(19) United States
(12) Patent Application Publication
(10) Pub. No.: US 2007/0034003 A1
(43) Pub. Date: Feb. 15, 2007

(54) Water-level control device having power frequency carrier

(75) Inventor: Yuan-Yu Huang, Taipei City (TW)

Correspondence Address: TROXELL LAW OFFICE PLLC, SUITE 1404, 5205 LEESBURG PIKE, FALLS CHURCH, VA, 22041, US

(73) Assignee: HANSDER ENGINEERING CO., LTD, Taipei City (TW)

(21) Appl. No.: 11/480,439

(22) Filed: Jul. 5, 2006

(30) Foreign Application Priority Data
Aug. 12, 2005 (TW) 094213795

(51) Int. Cl. G01F 23/30

(52) U.S. Cl. 73/308

(57) ABSTRACT

A control device obtains water level information and transfers the information to a control room through an indoor power unit coordinated with a unit for collecting the water level information and a unit for adding power frequency carrier carrying the water level information.

### FIELD OF THE INVENTION

The present invention relates to a control device; more particularly, relates to transferring information in a water-level control device to a control room for a user through an indoor power unit.

### DESCRIPTION OF THE RELATED ART

A prior art called a water-level monitoring device with a mutual power operation is disclosed in Taiwan, as shown in FIG. 5 and FIG. 6, where a minute-control circuit controls a mutual operation of two power sets, coordinated with two sets of multi-stage water-level indicators. The minute-control circuit comprises a microprocessor 6, an I/O unit 60, two power switches 61, two phase-failure detecting circuits 62, a transforming circuit for overload and electric-leakage signal 63, an alarm circuit 64, a water-level signal transforming circuit 65 and a display unit 66. Therein, the microprocessor 6 comprises signal connections with the above circuits through the I/O unit 60 and a bus; a key set is connected to an input pin of the microprocessor 6 for setting up functions by a user; the two power switches 61 control power sources for motors of the two power sets; input ends of the two phase-failure detecting circuits 62 are respectively connected to three-phase power supplies of the motors, and their output ends are connected to the microprocessor 6 through the I/O unit 60; the transforming circuit for overload and electric-leakage signal 63 obtains information of overload and electric-leakage from circuit breaker for overload and electric-leakage, where the circuit breaker is deposed on power source ends of the motors; and, input ends of the water-level signal transforming circuit 65 are respectively connected with metal probes 68 of two water-level detector 67 and their output ends are connected to the microprocessor 6 through the I/O unit 60. When installing, the metal probes 68 are deposed in upstairs and downstairs water towers with two water-level detectors 67 to transfer different signals of water level detected by the metal probes 68 to a display unit 66 66 for an operator to monitor the status of the water towers 7.

Although the operator can monitor the statuses of the water towers through the water-level monitoring device of the prior art, the wiring process for required power lines is complex, where the required power lines connect the water towers 7 and related control devices and then connect to a control room and so an origin of a damage in the power lines can not be found easily. Besides, the operator of the water-level monitoring device can obtain the statuses of the water-level monitoring device and the water towers 7; but, an ability of giving feedback to operate the motors is something short of. So, the prior art does not fulfill users' requests on actual

### SUMMARY OF THE INVENTION

The main purpose of the present invention is to transfer information in a water-level control device to a user-requested control room through an indoor power unit coordinated with a water-level signal unit and a transforming unit.

To achieve the above purpose, the present invention is a water-level control device having power frequency carrier, comprising a water-level signal unit connected with sensing probes and pumps, where each sensing probe is connected with a display unit; a transforming unit comprised of a power I/O module, a power carrier module, a single-chip control module and a signal I/O module, where the signal I/O module is connected with the water-level signal unit; and an indoor power unit connected with the power I/O module of the transforming unit. Accordingly, a novel water-level control device having power frequency carrier is obtained.

### BRIEF DESCRIPTIONS OF THE DRAWINGS

The present invention will be better understood from the following detailed description of the preferred embodiment according to the present invention, taken in con junction with the accompanying drawings, in which

FIG. 1 is a perspective view showing a preferred embodiment according to the present invention;

FIG. 2 is a block-diagram view showing the preferred embodiment according to the present invention;

FIG. 3 is a perspective view showing a state of use of the preferred embodiment according to the present invention;

FIG. 4 is a block-diagram view showing the state of use of the preferred embodiment according to the present invention;

FIG. 5 is a structural view of a prior art; and

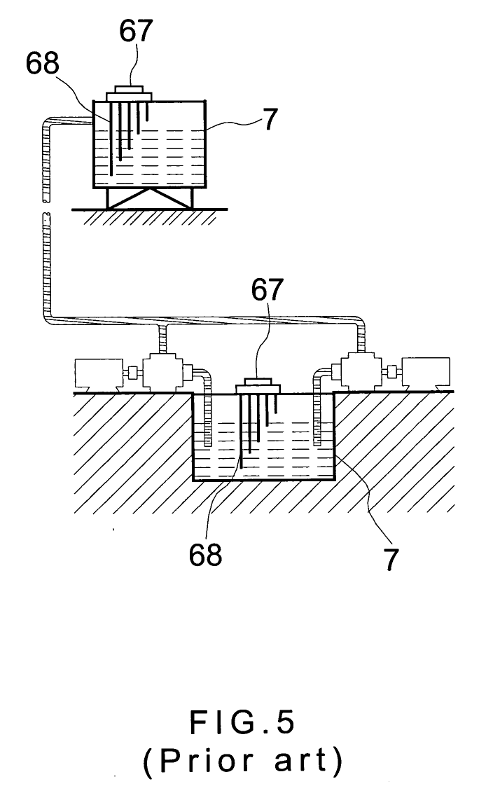

FIG. 6 is a circuit view of the prior art.

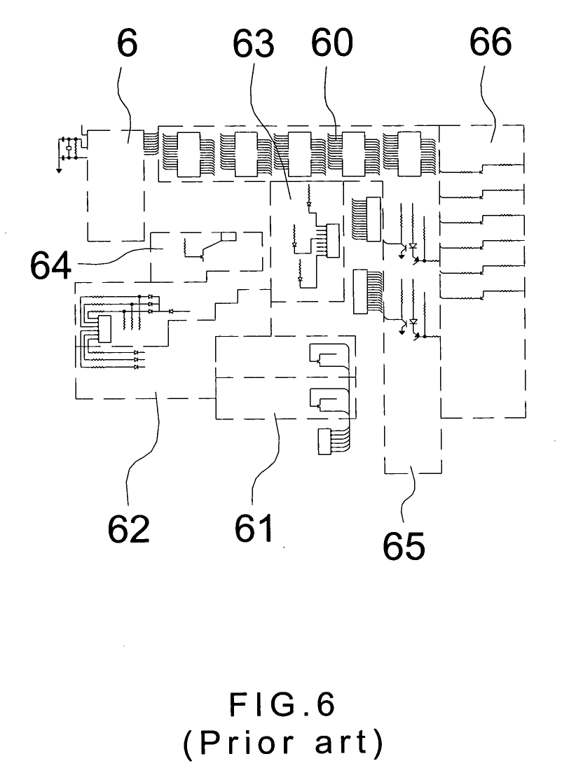

### DESCRIPTION OF THE PREFERRED EMBODIMENT

The following description of the preferred embodiment is provided to understand the features and the structures of the present invention.

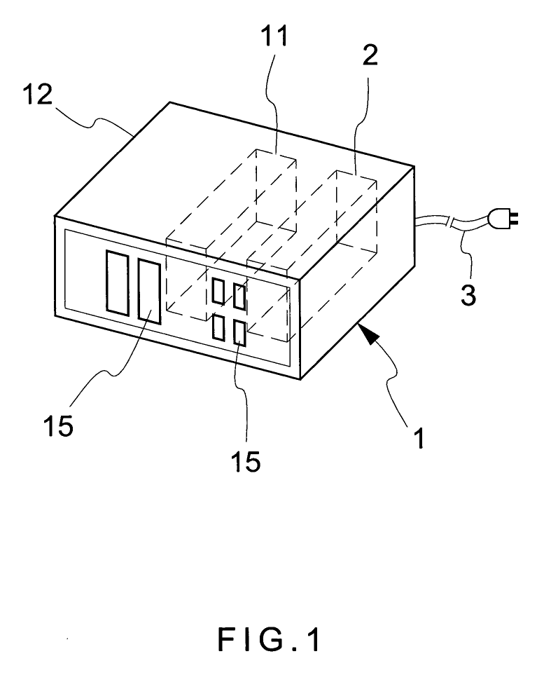

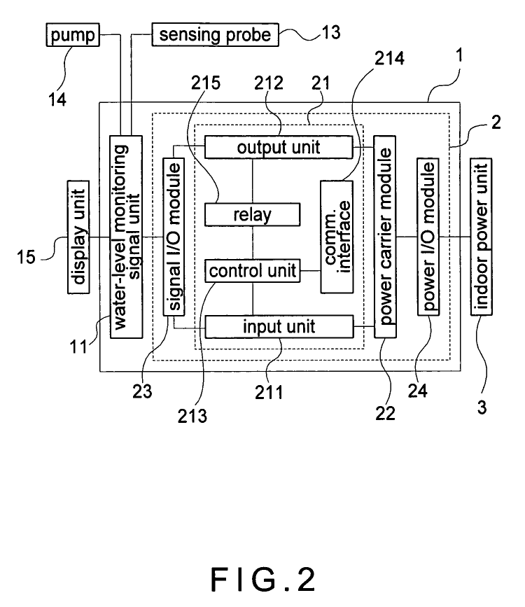

Please refer to FIG. 1 and FIG. 2, which are a perspective view and a block-diagram view showing a preferred embodiment according to the present invention. As shown in the figures, the present invention is a water-level control device 1 having power frequency carrier, comprising a water-level signal unit 11, a transforming unit 2 and an indoor power unit 3, where the water-level signal unit 11 and the transforming unit 2 are set in a case 12 and the indoor power unit 3 is located outside of the case 12 to directly transfer information from the water-level control device 1 using power frequency carrier through an indoor power line to a user-requested control room.

The water-level signal unit 11 is connected with a plurality of sensing probes 13 and pumps 14, where each sensing probe 13 is connected to a display unit 15 set in a control panel 121 on an end surface of the case 12.

The transforming unit 2 comprises a single-chip control module 21, a power carrier module with a transferring rate of 1200 BPS (bit per second), a signal I/O (input/output) module 23 and a power I/O module 24, where the signal I/O module is connected to the water-level signal unit 11. The single-chip control module 21 comprises an input unit 211, an output unit 212, a control unit 213, a communication interface 214 and a relay 215. The control module 213 is a 8051 single-chip processor having excellent inner structure with a working frequency up to 16 MHz, comprising a 4 k size of electrically programmable and erasable ROM (Read Only Memory), and eight input pins and eight output pins. The relay 215 is located at the output pins to quarantine the circuit for securing a n d ensuring the operation of the single-chip control module 21. The 8051 single chip contains a full-duplex communication interface 214 in side. The communication interface 214 can be an RS232 interface to transfer and receive data simultaneously from outside. Because the operational signals are on a TTL (transistor-transistor-logic) level (0 voltage set as logic 0; +5 voltage set as logic 1) and the communication interface 214 is a serial communication interface to transfer or receive data in a form of series of bits, linkages can be easily established between controllers (such as absorbing carrier, auto-detecting device, etc.), apparatuses and computers.

An end of the indoor power unit 3 is connected to the power I/O module 24 of the transforming unit 2; and the indoor power unit 3 comprises a plug for indoor power circuit.

With the above structure, a novel water-level control device having power frequency carrier is obtained.

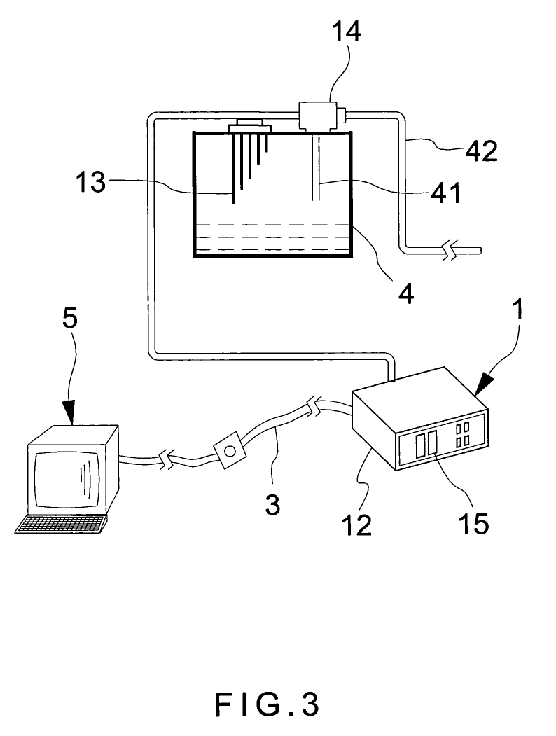

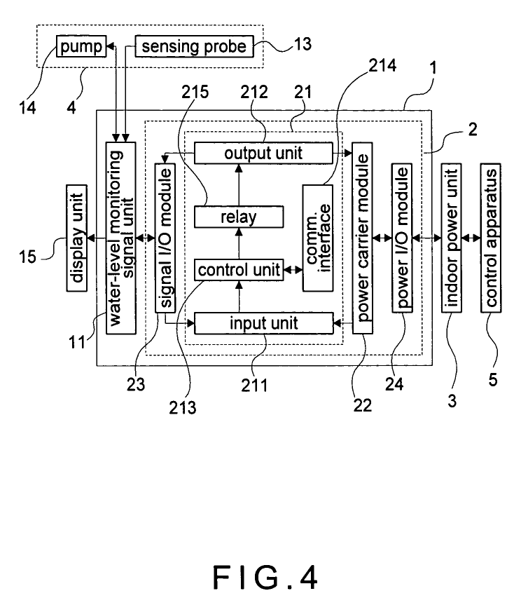

Please refer to FIG. 3 and FIG. 4, which are a perspective view and a block-diagram view showing a state of use of the preferred embodiment according to the present invention. As shown in the figures, the present invention can be applied to a livelihood water tower, a fire-fighting water tower, a cooling water tower or a factory water tower. When installing the present invention, sensing probes 13 are deposed in a water tower 4. Outlet ends 41 of pumps 14 are deposed in the water tower 4 and intake ends 42 of the pumps 14 are connected with water source. And a water-level control device 1 is deposed in a required place, such as a basement, a distribution box or a piping room. Then a plug of the indoor power unit 3 is plugged into an indoor power circuit. Hence, in a control room, an operator can obtain a control apparatus to plug into the indoor power circuit for obtaining water level information and controlling the water tower 4 by the water-level control device 1. Consequently, a water-level control device 1 according to the present invention is installed.

On operation, with the sensing probes 13 at different height levels, the water level information of the water tower 4, such as water level and abnormal status of the water tower 4 as well as information of the pumps 14, are sensed and transferred to a water-level signal unit 11 to be displayed by a display unit 15 for periodical examinations done by an operator. In the other hand, the water level information in the water-level signal unit 11 is also transferred to an input unit 211 of a single-chip control module 21 through a signal I/O module 23 of a transforming unit 2. After the information is received by the input unit 211, the information is then transferred to an output unit 212 through a control unit 213 and a relay 215. The information is then transferred through the output unit 212 to a power carrier module 22 to be modulated into power frequency carrier before transferring to a power I/O module 24. So, after the water level information, including water level and abnormal status of the water tower 4 as well as information of the pumps 14, is received by the power I/O module, the same information is then transferred to a control apparatus 5 in a control room through the indoor power u nit 3 along an indoor power line using the power frequency carrier. With the control apparatus 5 in the control room, an operator can obtain real-time water level information of water level and abnormal status of the water tower 4 as well as information of the pumps 14. If the water level of the water tower 4 is too low, the operator can also transfer a start signal using power frequency carrier by the control apparatus 5 to be received by the transforming unit 2. After the transforming unit 2 receives the start signal, the start signal is transferred to the water-level signal unit 11 to start required pumps for pumping water into the water tower 4 until a required water level.

To sum up, the present invention is a water-level control device having power frequency carrier, where information in a water-level control device can be transferred to a control room using power frequency carrier through an indoor power unit coordinated with a water-level signal unit and a transforming unit.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A water-level control device having power frequency carrier, comprising:
(a) a water-level signal unit connected with a plurality of sensing probes and a plurality of pumps, said sensing probe connecting to a display unit;
b) a transforming unit comprising a single-chip control module, a power carrier module, a signal I/O (input/output) module and a power I/O module, said signal I/O module connecting to said water-level signal unit; and
(c) an indoor power unit connecting to said power I/O module.

2. A control device according to claim 1,
wherein said water-level signal unit and said transforming unit are located in a case;
wherein said indoor power unit is located outside of said case; and
wherein an end surface of said case comprises a control panel having at least one display unit.

3. A control device according to claim 1, wherein said single-chip control module comprises an input unit, an output unit, a control unit, a communication interface and a relay.

4. A control device according to claim 1, wherein said control unit is a 8051 single chip.

5. A control device according to claim 1, wherein said control unit comprises a working frequency of 16 megahertz.

6. A control device according to claim 1, wherein said communication interface is an RS232 interface.

7. A control device according to claim 1, wherein said power carrier module comprises a transferring rate of 1200 BPS (bit per second).

8. A control device according to claim 1, wherein said indoor power unit comprises a plug for indoor power circuit.
